(19) United States
(12) Patent Application Publication
(10) Pub. No.: US 2024/0302523 A1
(43) Pub. Date: Sep. 12, 2024

(54) ELECTROMAGNETIC TOMOGRAPH FOR INHOMOGENEOUS MEDIA

(71) Applicants: DETECTION AND PROTECTION SYSTEMS (DPES) LTD., Beer Sheva (IL); RADIOVIDENIE LLC, Moscow (RU)

(72) Inventors: Nathan BLAUNSTEIN, Beer Sheva (IL); Vladimir YAKUBOV, Tomsk (RU); Sergey SHIPILOV, Seversk (RU); Rail SATAROV, Tomsk (RU); Andrei KLOKOV, Tomsk (RU); Dmitry SUKHANOV, Tomsk (RU); Ivan FEDIANIN, Tomsk (RU)

(21) Appl. No.: 18/039,522

(22) PCT Filed: Aug. 31, 2022
(86) PCT No.: PCT/IB2022/058177

§ 371 Date: May 31, 2023

Related U.S. Application Data
(60) Provisional application No. 63/239,968, filed on Sep. 2, 2021.

(51) Int. Cl. G01S 13/89; G01S 7/06; G01S 13/02; G01S 13/88

(52) U.S. Cl. CPC G01S 13/89; G01S 7/06; G01S 13/0209; G01S 13/885

(57) ABSTRACT

According to an aspect of the present disclosed subject matter, a method comprising: transmitting RF-transmission-signals incorporating at least one frequency produced by an apparatus and radiated in turns by an electromagnetic aerial interface toward each plane of a plurality of planes of a surveyed media; receiving RF-signals reflected from each plane of the plurality of planes in turn by the electromagnetic aerial interface, wherein each one of the RF-signals of each plane is characterized by phases amplitudes and frequencies; assembling a three-dimensional raw data array comprised of a plurality of two-dimensional raw data arrays, wherein each two-dimensional array comprises information elements of a different plane; reconstructing an image from the three-dimensional raw data array using an RF tomography technique, wherein the image depicts morphology and properties of inhomogeneities inside and beyond the surveyed media; and filtering artifacts out of the image based-on analysis of image quality measurements.

### TECHNICAL FIELD

The present disclosed subject matter relates to electromagnetics. More particularly, the present disclosed subject matter relates to radio tomography for determining locations, properties, and morphologies of objects in inhomogeneous media.

### CROSS-REFERENCE TO RELATED APPLICATION

This application claims priority under 35 U.S.C. § 119(e) from U.S. Provisional Patent Application No. 63/239,968, titled “ADVANCED ELECTROMAGNETIC TOMOGRAPHY TECHNIQUES AND NOVEL UWB/ESP RADARS FOR DETECTION AND IDENTIFICATION OF FOREIGN OBJECTS EMBEDDED IN SUB-SURFACE CLUTTER AND SUB-SOIL MEDIA”, filed on Sep. 2, 2021, which is incorporated in its entirety by reference herein.

### BACKGROUND

A subsurface survey is a noninvasive geophysical locating method that uses radio waves to capture images behind a media surface, e.g., soil. The benefit of such a method is to enable determining location and visualization of objects embedded or concealed underground without impacting the media and affecting (harming) the health of people using systems that implement the method.

Such equipment transmits electromagnetic energy ranging in the hundreds of Megahertz and employs a transmitter, a receiver, and an associated antenna. The transmitter sends electromagnetic signals into a clutter material (media) and the receiver processes signals that echo from subsurface objects and variations in the composition of the media.

The signal that hits the media and objects reflects, refracts, and scatters. The receiver detects and records echoes, i.e., the returning signals, and the system translates these echoes into information that depicts the objects in the subsurface.

Such subsurface survey systems can be used to find a wide range of items and are most effective when there is a significant variance between the electromagnetic property of the target and the surrounding material. The subsurface survey systems are often used to map and survey items made of conducting, semiconducting, and dielectric materials.

### BRIEF SUMMARY

According to one aspect of the present disclosed subject matter, an electromagnetic aerial interface adapted to transmit and receive Radio Frequency (RF), the electromagnetic aerial interface comprising: a plurality of conductors; a dielectric base having a side that accommodates the plurality of conductors; an adapter designed to control the plurality of conductors and conduct current to and from the plurality of conductors; and wherein the adapter is utilized to assign conductors of the plurality of conductors to be used as a transmitter conductor or as a receiver conductor, and wherein conductors of the plurality of conductors are spaced apart from one another to avoid coupling between conductors assigned as transmitters and conductors assigned as receivers.

In some exemplary embodiments, the dielectric base has some geometrical shape, wherein the side is configured to face a surveyed media, and wherein the plurality of conductors transmits RF signals to the surveyed media and receive RF signals reflected by the surveyed media.

In some exemplary embodiments, each conductor of the plurality of conductors is designed to transmit and receive RF signals ranging from hundreds to thousands of Megahertz (MHz) at a variable power range and in different phases.

In some exemplary embodiments, the plurality of conductors are used for transmitting Extremely-Short-Pulses (ESP) and continuous RF signals in an Ultra-Wide-Band (UWB) frequency range.

In some exemplary embodiments, each conductor of the plurality of conductors is made of a conductive alloy and has a size that ranges from a few millimeters to 30 millimeters.

In some exemplary embodiments, conductors of the plurality of conductors are spaced apart from one another by a length smaller than 1.5 times an average wavelength of transmitting and receiving frequencies to ensure a radio tomography focusing.

In some exemplary embodiments, the side of the dielectric base has a geometric profile selected from the group including: flat, concave, convex, parabolic, and any combination thereof.

In some exemplary embodiments, the adapter switches the plurality of conductors from transmission to reception and vice versa.

In some exemplary embodiments, the adapter assigns a portion of conductors as transmitting conductors and another portion as receiving conductors, and wherein the transmitting conductors and the receiving conductors are enabled simultaneously or alternately.

In some exemplary embodiments, the adapter assigns a plurality of segments each comprising at least one conductor designated as a transmitting conductor and at least one conductor designated as a receiving conductor, wherein the segments are activated, by the adapter, in queues so that each segment project RF signals and receive reflected RF signals from a different angle.

According to another aspect of the present disclosed subject matter, A Radio-Frequency (RF) tomograph utilizing RF signals to determine objects present in and beyond a cluttered surveyed media, the RF tomograph comprising: at least one electromagnetic aerial interface; an apparatus configured to produce RF-transmission-signals and process RF-signals and generate images depicting the objects; a display configured to display the images and information associated with the images; and wherein the apparatus uses the at least one electromagnetic aerial interface for transmitting RF-transmission-signals to the surveyed media and receiving RF-signals reflected from the surveyed media.

In some exemplary embodiments, the apparatus is a computerized system comprising: a processor; an RF transmitter; an RF receiver; and a memory unit.

In some exemplary embodiments, the RF transmitter is configured to shape RF-transmission-signals produced by the processor and transmit them by the at least one electromagnetic aerial interface and control the at least one electromagnetic aerial interface.

In some exemplary embodiments, the RF receiver is configured to receive and preprocess RF-signals from the at least one electromagnetic aerial interface followed by converting them into digital raw data and storing the raw data in the memory unit.

In some exemplary embodiments, the processor is also configured to reconstruct images from the raw data.

In some exemplary embodiments, the apparatus further comprises an auxiliary input amplifier configured to assist the RF-receiver in amplifying RF-signals.

In some exemplary embodiments, the apparatus further comprises an auxiliary output amplifier configured to assist the RF transmitter in boosting up RF-transmission-signals.

In some exemplary embodiments, the display is adapted to support graphic user interface functionalities to enable users of the RF tomograph to input information and instructions to the apparatus, and wherein the display is an integral part of the apparatus or connected to the apparatus as an external display selected from the group consisting of a touchscreen; a notepad; a laptop; a smartphone; a workstation; and any combination thereof.

In some exemplary embodiments, the RF tomograph is an RF tomograph configured to operate in transmission applications, wherein the at least one electromagnetic aerial interface is comprised of one electromagnetic aerial interface configured as a receiving antenna and a second electromagnetic aerial interface configured as a transmitting antenna, wherein the transmitting antenna and the receiving antenna are facing opposite ends of the surveyed media, and wherein the RF tomograph moves the surveyed media between the transmitting antenna and the receiving antenna.

In some exemplary embodiments, the RF tomograph is an RF tomograph configured to operate in reflection mode, wherein the at least one electromagnetic aerial interface is mounted on a movable device configured to move along the surveyed media while the at least one electromagnetic aerial interface transmit RF signals toward the surveyed media and receive reflected RF signals from the surveyed media, and wherein the apparatus synchronizes the signals with coordinates of the mobile device while moving along the surveyed media.

In some exemplary embodiments, the at least one electromagnetic aerial interface is an antenna selected from the group including: a parabolic antenna, Rupor antenna, a Yagi antenna, an array antenna, and any combination thereof.

In some exemplary embodiments, the RF tomograph is an RF tomograph configured to operate in reflection application that utilizes the antenna in stationary position, wherein the antenna is configured to transmit RF-transmission-signals adapted to penetrate a barrier and receive RF-signals reflected back, through the barrier from at least one entity moving behind the barrier, wherein the apparatus further comprises a camera configured to determine coordinates of at least one entity moving behind the barrier, and wherein the apparatus synchronizes the signals with coordinates of the at least one entity moving behind the barrier.

In some exemplary embodiments, the RF tomograph is an RF tomograph configured to operate in reflection mode utilizing a receiving antenna and a transmitting antenna, wherein the receiving antenna and the transmitting antenna are mounted on a vehicle configured to move along the surveyed media while transmitting RF-transmission-signals toward the surveyed media and receiving reflected RF-signals from the surveyed media, and wherein the apparatus synchronizes the signals with coordinates of the vehicle while moving along the surveyed media.

According to yet another aspect of the present disclosed subject matter, a method comprising: transmitting RF-transmission-signals incorporating at least one frequency produced by an apparatus and radiated in turns by an electromagnetic aerial interface toward each plane of a plurality of planes of a surveyed media; receiving RF-signals reflected from each plane of the plurality of planes in turn by the electromagnetic aerial interface, wherein each one of the RF-signals of each plane is characterized by phases amplitudes and frequencies; assembling a three-dimensional raw data array comprised of a plurality of two-dimensional raw data arrays, wherein each two-dimensional array comprises information elements of a different plane; reconstructing an image from the three-dimensional raw data array using an RF tomography technique, wherein the image depicts morphology and properties of inhomogeneities inside and beyond the surveyed media; and filtering artifacts out of the image based-on analysis of image quality measurements.

In some exemplary embodiments, the transmitting further comprises determining, by a processor, magnitudes frequencies and phases parameters of the RF-transmission-signals and retaining the parameters in a corresponding two-dimensional raw data array.

In some exemplary embodiments, the transmitting further comprises generating, by a transmitter, RF-transmission-signals in Ultra-Wide-Band (UWB) ranging from hundreds to thousands of Megahertz (MHZ) and Extremely-Short-Pulses (ESP).

In some exemplary embodiments, the transmitting further comprises instructing the electromagnetic aerial interface, by the processor, on which conductors to use for reception and transmission and when.

In some exemplary embodiments, the receiving further comprises amplifying and preprocessing the RF-signals, wherein the preprocessing comprises determining amplitude, phase, shape, and frequencies of each RF-signal and digitizing each RF-signal into digital values that form an information element incorporating amplitude, phase, shape, and frequencies of the RF-signal.

In some exemplary embodiments, the receiving further comprises simultaneous amplifying and preprocessing a plurality of RF-signals received from a plurality of electromagnetic aerial interface.

In some exemplary embodiments, the receiving further comprises retaining information elements in a corresponding two-dimensional raw data array.

In some exemplary embodiments, the plurality of two-dimensional raw data arrays are derived from incremental-sampling of a plane after plane along the surveyed media, wherein the distance between planes is smaller than half the wavelength of a maximum frequency of the RF-transmission signal.

In some exemplary embodiments, the assembling further comprises incorporating coordinates of the electromagnetic aerial interface at each plane along the surveyed media into the information elements of a corresponding two-dimensional raw data array of the plane.

In some exemplary embodiments, the RF tomography technique comprises a synthesized-focusing-technique selected from the group consisting of inverse focusing; single focusing; two-step focusing; group focusing; and double focusing; and any combination thereof.

In some exemplary embodiments, the reconstructing further comprises invoking a time domain reflection-transform-algorithm of the RF tomography technique for reflection applications and a frequency domain transmission-transform-algorithm of the RF tomography technique for transmission applications.

In some exemplary embodiments, the time domain reflection-transform-algorithm comprises focusing the information elements of the three-dimensional raw data array, wherein the focusing comprises: executing the synthesized-focusing-technique for calculating an average time difference between the RF-transmission signal and the RF-signals in each plane; summing values of all the RF-signals of each plane; determining a time delay factor of each plane; and normalizing information elements by corresponding time delay factor.

In some exemplary embodiments, the frequency domain transmission-transform-algorithm comprises an optical approximation for transforming values of the information elements that are given as electrical field distributed in three-dimensional space into a two-dimensional distribution of the refractive index in the frequency domain.

In some exemplary embodiments, the frequency domain transmission-transform-algorithm further comprises focusing the information elements of the three-dimensional raw data array, wherein focusing comprises convolution calculations of inverse focusing of crossing planes.

In some exemplary embodiments, the measurements comprise measuring noise level and edge contrast, and wherein the analysis of image quality is based on neural network algorithms.

In some exemplary embodiments, the filtering further comprises altering reconstruction parameters associated with permittivity and frequency range and recalculating the synthesized-focusing technique followed by the reconstruction.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

### In the Drawings:

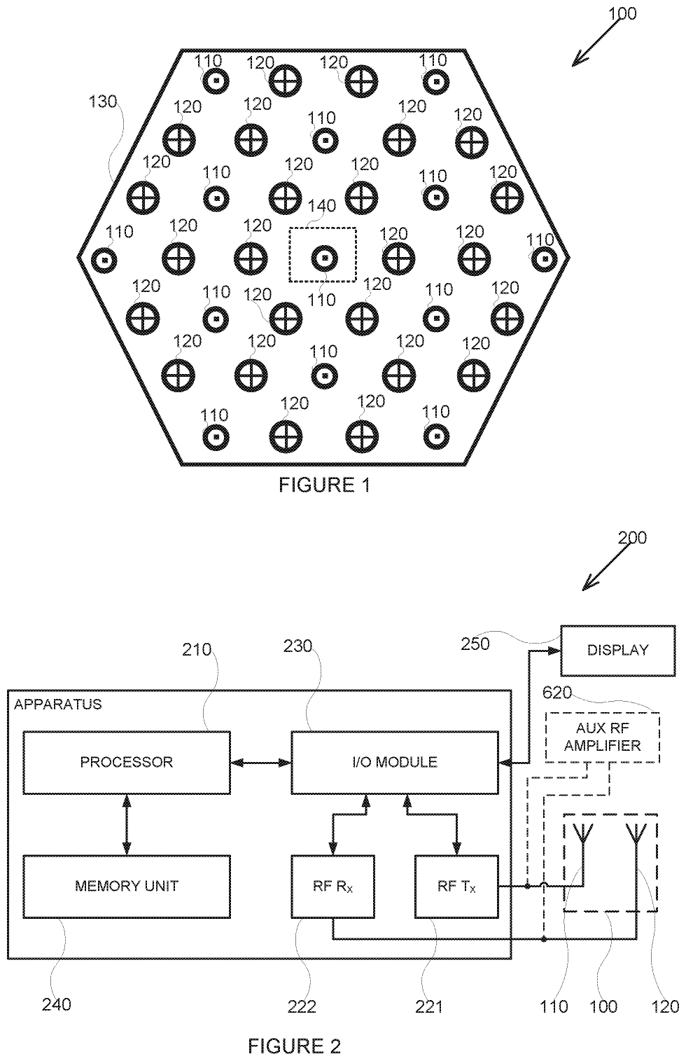

FIG. 1 illustrates a front view of an Antenna array, in accordance with some exemplary embodiments of the disclosed subject matter;

FIG. 2 shows a block diagram of an apparatus of a Radio Frequency Tomograph (RFT) system, in accordance with some exemplary embodiments of the disclosed subject matter;

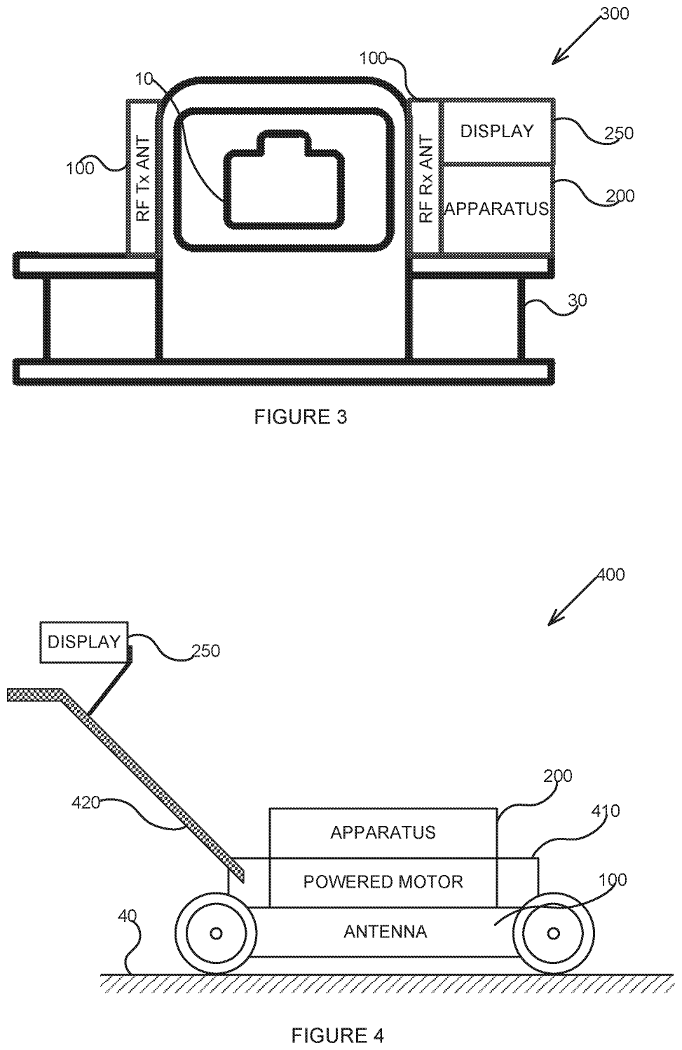

FIG. 3 illustrates a side view of a first RFT system, in accordance with some exemplary embodiments of the disclosed subject matter;

FIG. 4 illustrates a side view of a second RFT system, in accordance with some exemplary embodiments of the disclosed subject matter;

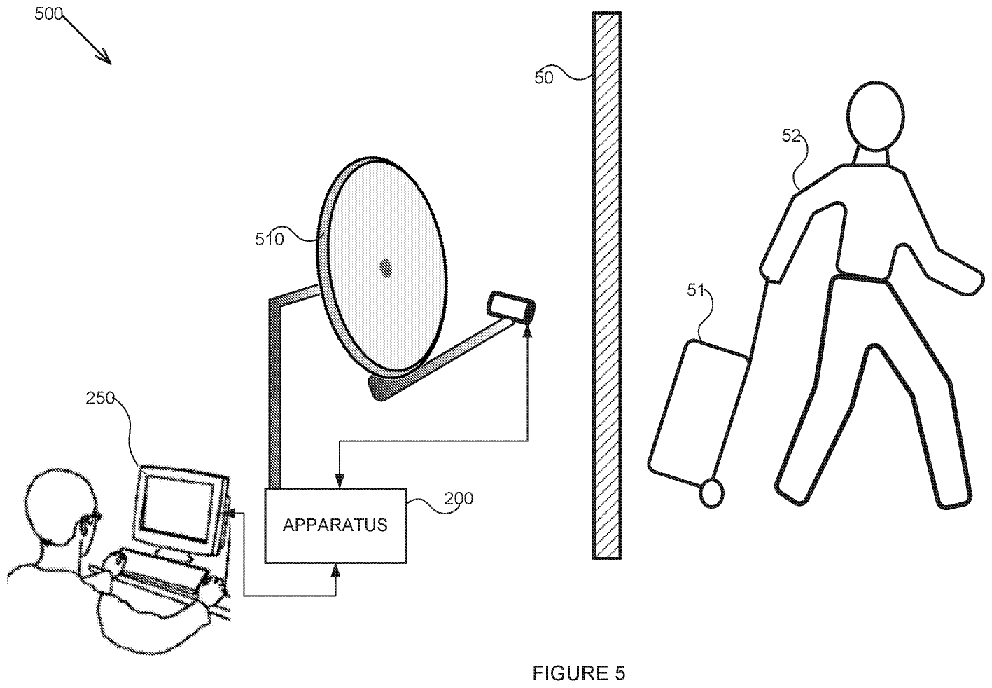

FIG. 5 illustrates a side view of a third RFT system, in accordance with some exemplary embodiments of the disclosed subject matter;

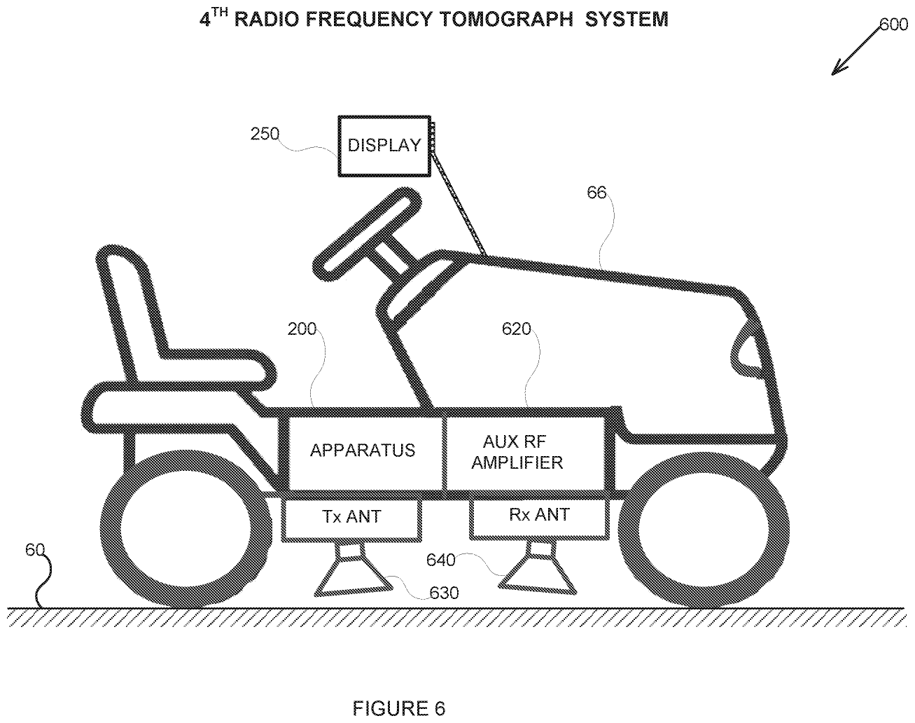

FIG. 6 illustrates a side view of a fourth RFT system, in accordance with some exemplary embodiments of the disclosed subject matter; and

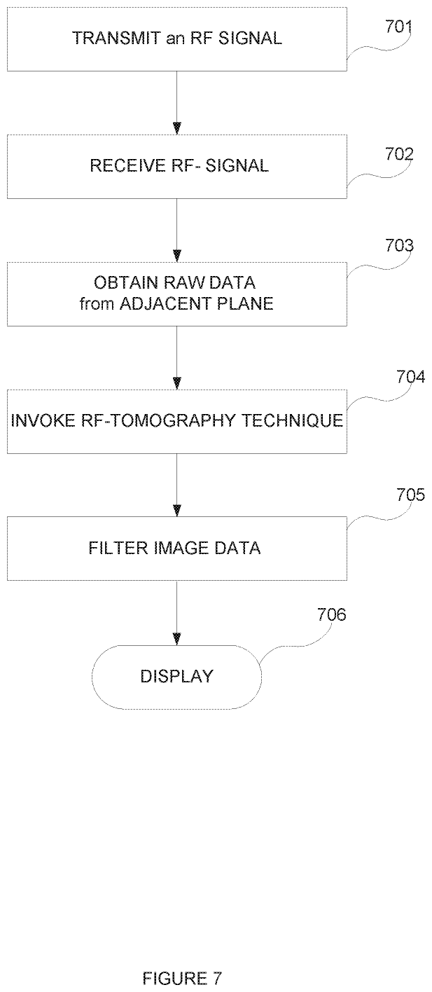

FIG. 7 shows a flowchart diagram of a method, in accordance with some exemplary embodiments of the disclosed subject matter.

### DETAILED DESCRIPTION

One technical solution implemented in the present disclosure is a synthesized-focusing technique comprising inverse, single, two-step, and group focusing techniques, which may be based on mathematical approximation approaches (to be described in detail further below). In some exemplary embodiments, the synthesized-focusing technique can be used for mitigating multi-diffraction and multi-scattering phenomena manifested in signals obtained from surveyed objects and cluttered inhomogeneous media.

Another technical solution implemented in the present disclosure is a double-focusing technique used to reduce multiple interactions between radiation and matter, thereby providing better localization of objects in a radiation-media interaction environment, i.e., weakening multiple interactions between radiation and matter. In some exemplary embodiments, double-focusing comprises applying the single-focusing technique on integrals of measurements obtained from a given plane of a media surface, e.g., soil. Followed by applying another single-focusing technique on a plane traversing the given plane, and then determining an accurate localization of objects in a region by convolution calculation of the product of the result of two crossings single-focusing results.

Yet another technical solution implemented in the present disclosure is an RF-tomography technique used in reflecting reflection applications. The RF-tomography technique may be utilized to extract relevant information from received incoherent radiation influenced by diffraction and multi-scattering. In some exemplary embodiments, systems of the present disclosure utilize an adapted radio-holographic principle to filter out interfering radiation received from the aperture of any antenna array.

In some exemplary embodiments, the RF-tomography technique may be used in transmission applications, where a receiving antenna and a transmitting antenna are situated on opposite sides of a medium. This RF tomography technique may be utilized as a filter comprising a breakdown scheme of nonuniform microwave fields, e.g., phase approximation (to be described in detail further below), “Green's” function, and the synthesized-focusing techniques to facilitate filtering out multi-diffraction caused by an object's contours, and multi-scattering from cluttered media. Thus, enabling image reconstruction of objects embedded/hidden in cluttered media, where dimensions of inhomogeneities exceed the radiated wavelengths.

It will be appreciated that for both applications, i.e., reflection and transmission applications, utilizing the RF-tomography technique of the present disclosure are basically the same, however, contain adjustments for each application, which will be described in detail further below.

In some exemplary embodiments, the transmission RF-tomography technique may be used for an end-to-end traverse survey of a media employing shadow projection tomography and a Fourier synthesis method. However, wave projections cannot be considered pure shadow projections since wave diffraction and interference, as well as multiple wave interactions, are relevant in radio-waves analysis. In some exemplary embodiments, utilizing the double-focusing technique enables minimizing the influence of multiple interactions. Since diffraction and interference cannot be resolved with a single interaction, particularly in semi-transparent media, the transmission RF-tomography technique alone increases the phase taper of partial waves leading to multiple interactions on individual RF radiation. To mitigate this problem, the system of the present disclosure utilizes a phase approximation.

Referring now to FIG. 1 illustrating a front view of an antenna, in accordance with some exemplary embodiments of the disclosed subject matter.

Antenna 100 may be an electromagnetic aerial interface between radio waves propagating through space and electric currents moving in conductors or radiating from media. Antenna 100 may be used in the present embodiment as an Ultra-Wide-Band (UWB) and Extremely-Short-Pulse (ESP) antenna utilized to transmit and receive continuous and/or pulse RF signals ranging from 2 to 12 Giga Hertz (GHz). The RF signals can be transmitted to a cluttered medium in power ranging from milliwatts up to tens of watts and in varying phases.

In some exemplary embodiments, Antenna 100 is utilized in a variety of Radio Frequency Tomograph (RFT) systems for detecting, identifying, and depicting morphologies of objects having a variety of electric properties that are embedded in semi-transparent and non-transparent clutter media, such as soil, walls, rocks, and the like, or any combination thereof.

It should be noted that an Antenna array configuration of Antenna 100, is a bi-static configuration, having an increased and dense number of antennas (conductors) that improve the RF tomography focusing, with respect to the monostatic location of a transmitter antenna and a receiver antenna located at the same point.

In some exemplary embodiments, Antenna 100 may be implemented as an antenna array comprising a plurality of conductors, which may be defined as Transmitting Antennas (Tx-Ant) 110 as Receiving Antennas (Rx-Ant) 120. In some exemplary embodiments, the ratio between the number of Rx-Ant 120 and the Tx-Ant 110 is typically, but not limited to, 2:1. In some exemplary embodiments, the conductors may be assembled on one side of a dielectric Base 130. Each conductor of the plurality of conductors, e.g., Tx-Ant 110 and/or Rx-Ant 120, conductors may be wired to a transmitter and/or a receiver via an electronic Adapter 140. In some exemplary embodiments, Adapter 140 may be utilized to assign, by electronically switching, one or more conductors to be used as a transmitter conductor, i.e., Tx-Ant 110, or as a receiver conductor i.e., Rx-Ant 120. Additionally, or alternatively, Adapter 140 may be configured to assign a portion of conductors as transmitting conductors and another portion as receiving conductors while the transmitting conductors and the receiving conductors are enabled simultaneously or alternately.

It will be appreciated that the distance between two neighboring antennas, i.e., Rx-Ant 120, Tx-Ant 110, or any combination thereof, may be typically less than 1.52 of utilized transmitted wavelengths to avoid coupling between neighboring antennas and to facilitate radio tomography focusing. In some exemplary embodiments, Rx-Ant 120, and Tx-Ant 110 may be made of a room temperature, superconductive alloy or any commercially available conductive material.

In some exemplary embodiments, a Base 130 of Antenna 100 is hexagon-shaped and has overall dimensions of approximately 45 by 45 centimeters that comprise 24 Rx-Ants 120 and 13 Tx-Ants 110, wherein the size of each conductor, e.g., Tx-Ant 110 or Rx-Ant 120, ranges from a few millimeters to 30 millimeters. However, it will be noted that the Antenna-array of the present disclosure can be provided in different geometric shapes, sizes, and amounts of Rx-Ants 120 and Tx-Ants 110. Additionally, Base 130 may be provided in geometric profiles, such as flat, concave, convex, and the like, or any combination thereof.

In some exemplary embodiments of the disclosed subject matter, a portion or all the Tx-Ant 110 may be utilized as receiving antennas, and a portion or all the Rx-Ant 120 as transmitting antennas. This functionality may be obtained by periodically activating a predetermined number of antennas as receiving antennas and the others as transmission antennas. At each period, a specific combination of Rx-Ant 120 and Tx-Ants 110 can be realized. Such functionality is referred to hereinafter, as a Clocked-antenna array. Utilizing Clocked-Antenna-array functionality yields numerous varied combinations of Rx-Ant 120 and Tx-Ants 110. It should be noted that Rx-Ant 120 and Tx-Ant 110 may be activated (enabled) simultaneously or alternately.

In some exemplary embodiments, conductors of Antenna 100 may be assigned as segments. Each segment comprises at least one Rx-Ant 120 and at least one Tx-Ants. The segments are allocated geometrically along Antenna 100 so that when activated in queues each segment transmits (radiates) RF signals and receives (reflected) RF signals from a different angle.

In some exemplary embodiments of a bi-static configuration, a distance between any given Tx-Ant 110 [m1] and its associated Rx-Ant 120 [n1] may vary between 1 to 100 millimeters, depending on size, shape, and application of the Antenna-array. Consequently, the range between that Tx-Ant 110 [m1] to any given element [r] in an object is ultimately different from the range between [r] to [n1]. Thus, in a way, a distance [d] between Tx-Ant 110 and its associated Rx-Ant 120 defines the spatial resolution of the antenna. Therefore, [d] can be the smallest detectable size of an element within the object. In some exemplary embodiments, RFT systems may be calibrated by normalizing the samplings of the receivers accordingly.

Additionally, or alternatively, measurement values obtained by any given Rx-Ant 120 may be compensated with values of measurements of neighboring Rx-Ants 120. Also, the spatial resolution of Antenna 100 may be improved by retransmitting the signal after electronically switching between the Tx-Ant 110 and the Rx-Ant 120.

In some exemplary embodiments, Parabolic Antennas, Rupor Antennas, and Yagi Antennas (not shown) can be used in the RFT systems of the present disclosure. The specifications and functionality of such antennas are known in the art, and thus a detailed description is omitted. It will be noted that, according to the application, these antennas may be utilized as a transmission dedicated antenna, a reception dedicated antenna, a transceiver antenna, and the like, or any combination thereof.

Referring now to FIG. 2 showing a block diagram of components of an apparatus, in accordance with some exemplary embodiments of the disclosed subject matter.

An Apparatus 200 may be a computerized apparatus adapted to perform methods such as the method depicted in FIG. 7. In some exemplary embodiments, Apparatus 200 may comprise a Processor 210. Processor 210 may be a Central Processing Unit (CPU), a microprocessor, an electronic circuit, an Integrated Circuit (IC), or the like. Additionally, or alternatively, Apparatus 200 can be implemented as firmware written for or ported to a specific processor such as Digital Signal Processor (DSP) or microcontrollers or can be implemented as hardware or configurable hardware such as field programmable gate array (FPGA) or application specific integrated circuit (ASIC). Processor 210 may be utilized to perform computations required by Apparatus 200 or any of its subcomponents.

In some exemplary embodiments of the disclosed subject matter, Apparatus 200 may comprise an Input/Output (I/O) Module 230. Apparatus 200 may utilize I/O Module 230 as an interface to transmit and/or receive information and instructions between Apparatus 200 and external I/O devices, such as a Display 250, the Internet (not shown), or the like.

In some exemplary embodiments, I/O Module 230 may be used to provide an interface to users of RFT Systems, such as by providing output, visualized results, reports, images, or the like using a Display 250.

Display 250 may also be used, by users, to input information to Apparatus 200, such as operating instructions, survey criteria, setup parameters, any combination thereof, or the like. Additionally, or alternatively, Display 250 may be adapted to support graphic user interface (GUI) functionalities to enable users to input information and instructions to Apparatus 200. In some exemplary embodiments, Display 250 may be integrated in Apparatus 200 or connected externally to Apparatus 200. In some exemplary embodiments, Display 250 may be a touchscreen, a notepad, a laptop, a smartphone, or a workstation.

Additionally, or alternatively, an internet connection or another commercially available radio communication method, may be used to provide remote users of the system, with input and output information. It will be appreciated that Apparatus 200 can operate without human operation.

In some exemplary embodiments, Apparatus 200 may comprise an RF Transmitter (RF-Tx) 221 and an RF Receiver (RF-Rx) 222. RF-Tx 221 and RF-Rx 222 may be RF amplifiers configured to operate at frequencies ranging from 1 GHz to 15 GHz. RF-Tx 221 and RF-Rx 222 may be controlled by Processor 210 via I/O Module 230, which may also serve as a data acquisition port for signals acquired by Rx-Ant 120, and amplified by RF-Rx 222. In some exemplary embodiments, Apparatus 200 may utilize an external auxiliary input amplifier configured to assist RF-Rx 222 in amplifying RF-signals.

Additionally, or alternatively, RF-Rx 222 may comprise a converter for digitizing RF signals into digital values of the RF signals. In some exemplary embodiments, RF-Rx 222 may comprise at least one converter, such as an Analog to Digital Converter (ADC); a multiport analyzer for acquiring amplitudes, phases of each frequency of received UWB signal; a stroboscopic sample and hold; a quadrature receiver having signal digitization; a digital signal processor, and any combination thereof, or the like.

In some exemplary embodiments, the digital values of each RF signal constitute an information-element including various parameters, such as: the frequency, the phase, and the amplitude of each acquired RF signal. Each information-element may be stored, by Processor 210, in a raw data array wherein each information-element is associated with a different received RF signal.

In some exemplary embodiments, RF-Tx 221 may get signals generated by Processor 210 via I/O Module 230, shape and amplify them to the power level of hundreds of watts and emit them as transmission RF signals by Tx-Ant 110. Additionally, or alternatively, Apparatus 200 may utilize an external auxiliary RF amplifier (e.g., AUX 620, of FIG. 6) in boosting up the power output of RF-Tx 221 (transmission RF signals) to levels of tens of kilowatts and emit them by Tx-Ant 110. It should be noted that in some exemplary embodiments, the desired power may be a product of high voltage, e.g., kilovolts, and low current, e.g., milliamperes.

In some exemplary embodiments, Apparatus 200 may comprise a Memory Unit 240. Memory Unit 240 may be persistent or volatile. Memory Unit 240 may be comprised of volatile and/or non-volatile memories, based on technologies such as semiconductor, magnetic, optical, flash, a combination thereof, or the like.

For example, Memory Unit 240 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like.

In some exemplary embodiments, Memory Unit 240 may retain program code, digitized raw data arrays made by RF-Rx 222, reconstructed images, vectors, and matrixes used by Processor 210 to perform acts associated with any of the steps shown in FIG. 7

The components detailed below may be implemented as one or more sets of interrelated computer instructions, executed for example by Processor 210 or by another processor. The components may be arranged as one or more executable files, dynamic libraries, static libraries, methods, functions, services, or the like, programmed in any programming language and under any computing environment.

Referring now to FIG. 3 illustrating a side view of a first Radio Frequency Tomograph (RFT) System, in accordance with some exemplary embodiments of the disclosed subject matter.

RFT System 300 may be provided as a scanner for visualization, and recognition of objects of interest, embedded or hidden in luggage, closed containers, packages, or the like. RFT System 300 may be used in scientific applications, mail and delivery services, military, and law enforcement agencies, such as border control, customs screening, or the like. In some exemplary embodiments, RFT System 300 may be deployed as a standalone portable system, or integrated with a baggage Scanner 30, such as a conveyor belt scanner used in security checkpoints of airports.

In some exemplary embodiments, RFT System 300 can be integrated with a Scanner 30 for scanning Baggage 10. It will be appreciated that, unlike commercially available baggage scanners, RFT System 300 does not utilize ionizing energy, such as x-ray, as the commercially available baggage scanners do. Instead, RFT System 300 of the present disclosure transmits 5 to 10 watts of RF energy at a frequency range of 2 GHz to 12 GHz.

In some exemplary embodiments, RFT System 300 may be comprised of a two Antenna-array, e.g., two Antennas 100 of FIG. 1, where one Antenna-array may be configured as a transmitting antenna and the other as a receiving antenna. RFT System 300 further comprises Apparatus 200 and Display 250, of FIG. 2, configured to control RFT System 300 and perform acts associated with any of the steps shown in FIG. 7. In some exemplary embodiments, the technical characteristics of RFT System 300 in some embodiments, may be:
a. Less than 2 cm spatial resolution of the object in the horizontal plane.
b. Less than 4 cm spatial resolution of the object in the vertical plane.
c. Less than 8 seconds for image visualization.
d. Up to one meter distance to a tested object 10.

Antennas 100 of RFT Systems 300 are permanently affixed to Scanner 30, whereas Object 10 moves along a trajectory within Scanner 30. In such embodiment, coordinates of each incremental-sampling (to be described in detail further below) of Antennas 100 relative to Object 10 may be provided by an encoder of Scanner 30 (not shown) to Apparatus 200.

In some exemplary embodiments of the disclosed subject matter, RFT System 300 may be used as a standalone system where the object does not move on a conveyor belt in Scanner 30 (in contrast to what is described above). In such embodiment, the tomography scanning may be performed by activating consecutive antenna portions (conductors) in the Antenna-array to make up for the lack of movement and to achieve different projection angles.

Referring now to FIG. 4 illustrating a side view of a second RFT system, in accordance with some exemplary embodiments of the disclosed subject matter.

RFT System 400 may be provided as a system for surveying and investigating subsoil and man-made media to detect metal and dielectric objects, such as cables, pipes, mines, caches, or the like, embedded or hidden inside the media. In some exemplary embodiments, RFT System 400 may be used to analyze Media 40, such as asphalt, rock, soil, ice, pavements, concrete, brick structures, and the like, or any combination thereof.

RFT System 400 may be used in scientific applications, military applications, law enforcement agencies, geology surveys, municipality services, civil constructions, or the like. In some exemplary embodiments. RFT System 400 may be provided as a manually propelled standalone Mobile-Cart 420. Additionally, or alternatively, RFT System 400 may be integrated within a remote-controlled robot or a drone (not shown) or simply dragged by a vehicle (not shown).

In some exemplary embodiments, RFT System 400 may be comprised of an Antenna-array, such as Antenna 100 of FIG. 1, configured to emit RF energy with its Tx-Ants 110 (of FIG. 1) and receive waves reflected from Media 40 by Rx-Ants 120 (of FIG. 1). RFT System 400 may also comprise Apparatus 200 and Display 250, of FIG. 2, configured to control RFT System 400 and perform acts associated with any of the steps shown in FIG. 7. In some exemplary embodiments, RFT System 400 may be integrated onto Mobile-Cart 420 comprising a remote-controlled Powered-Motor 410, thereby imparting RFT System 400 a robot functionality.

In some exemplary embodiments, RFT System 400 may be configured to transmit RF signals at frequencies ranging from 2 GHZ to 12 GHz. The transmitted RF energy may be determined based on a required survey penetration depth and/or the properties of the media, for example, approximately 100 Watts for one-meter penetration, approximately 400 Watts for 2 meter penetration, and a few KW for five meter penetration. In some exemplary embodiments, the spatial resolution can be less than 2 cm in both vertical the horizontal planes.

In some exemplary embodiments, RFT System 400, as well as Antenna 100, are permanently affixed to Mobile-Cart 420 and move together along a trajectory above a Media 40. In some exemplary embodiments, Apparatus 200 may comprise a positioning system (not shown), such as GPS, Real-Time Locating System (RTLS), and the like, or any combination thereof. In such embodiments, coordinates of each incremental-sampling (to be described in detail further below) of Antennas 100 relative to Media 40 may be provided by a positioning system (not shown). In some exemplary embodiments of the disclosed subject matter, an RFT System may be installed on a drone (not shown) hovering/flying along a trajectory above a surveyed media. In such embodiments, the coordinates of each incremental-sampling made by the drone's antennas may be obtained in a similar fashion to RFT System 400.

In some exemplary embodiments, RFT System 400 may provide information comprising subsurface layers restoration (slices), detection and mapping of heterogencities in the subsurface layers, and determining their location, shape, and size, in addition to digitally reconstructing and displaying 3D images of embedded objects' morphology within a few seconds.

Referring now to FIG. 5 illustrating a side view of a third RFT system, in accordance with some exemplary embodiments of the disclosed subject matter.

RFT System 500 may be utilized as a UWB radar system for detecting and identifying objects, such as electronic devices, metallic elements, dielectric and composite materials, e.g., explosives, hidden on a human's body (Entity 52), or inside carry-on packages (Entity 51). In some exemplary embodiments, Entities 51, and 52 are in a radio-transparent environment, e.g., air (i.e., an unobstructed environment), or behind a radio-opaque Barrier 50, e.g., a wall. While RFT System 500 may be situated on an opposite side of Barrier 50 at a distance of about 10 meters, depending on the size of a parabolic Antenna 510.

RFT System 500 may be configured to produce images depicting the morphologies of objects of interest embedded or hidden on Entity 52 and in Entity 51, such as luggage, closed containers, packages, or the like. In some exemplary embodiments, RFT System 500 may be used in scientific applications, military applications, and law enforcement agencies, such as border control, customs screening, or the like. In some exemplary embodiments, RFT System 500 may be deployed in venues hidden from people under surveillance.

In some exemplary embodiments, RFT System 500 may be include a parabolic Antenna 510 configured to transmit RF signals and receive waves reflected by Entities 51 and 52 through Barrier 50. Antenna 510 can be provided in diameters varying between 30 and 50 centimeters (cm) that yield a beam width of about 15 cm at a distance of 5 meters, both in azimuthal and elevation domains.

RFT System 500 may also include an Apparatus 200 and a Display 250, of FIG. 2, configured to control RFT System 500 and perform acts associated with any of the steps shown in FIG. 7. In some exemplary embodiments, RFT System 500 can be configured to transmit RF signals at frequencies ranging from 2 GHz to 12 GHz. The transmitted RF energy of the signals may be determined based on characteristics of Barrier 50 composition, i.e., its opaqueness to RF energy, and the distance from the objects. Additionally, or alternatively, the transmitted RF energy of the signals may be also determined based on a frequency bandwidth in which Barrier 50 may be near transparent to RF energy. In some exemplary embodiments, the signals' transmitted RF energy may be set up to several tens of watts when Antenna 510 is situated up to about 10 meters apart from Entities 51 and/or 52. Lower RF energy may be set for distances shorter than 10 meters.

In some exemplary embodiments, Antenna 510 of RFT System 500 is stationary, however, Entities 51 and 52 move along a trajectory behind Barrier 50. In such embodiment, coordinates of each incremental-sampling (to be described in detail further below) of Antenna 510 relative to Entities 51 and 52 may be determined by Apparatus 200 utilizing a camera (not shown) situated behind Barrier 50 that depicts the motion of Entities 51 and 52.

FIG. 6 illustrates a side view of a fourth RFT system, in accordance with some exemplary embodiments of the disclosed subject matter.

RFT System 600 may be provided as a scanner, employing UWB/ESP radar, for surveying and investigating deep subsoil and man-made Media 60, to detect embedded or hidden metal and/or dielectric objects, such as cables, pipes, mines, caches, underground tunnels, geology morphology, underground rivers, mineral, archeological ruins, and any combination thereof, or the like. In some exemplary embodiments, RFT System 600 may be used to analyze Media 60, such as asphalt, rock, soil, ice, pavements, concrete and brick structures, and any combination thereof, at a probing depth of a few meters with a spatial resolution of 5 to 10 cm.

RFT System 600 may be used in scientific applications, military applications, law enforcement, geology surveys, municipality services, civil constructions, or the like. In some exemplary embodiments, RFT System 600 may be integrated with vehicles, such as Vehicle 66. Alternatively, RFT System 600 can be installed on a towed trailer (not shown). It should be noted that in the surveying process of Media 60, Vehicle 66 moves at a constant speed ranging between 5 to 25 meters/Sec.

RFT System 600 may be comprised of a transmitting antenna (Tx-Ant) 630, a receiving antenna (Rx-Ant) 640, an auxiliary RF amplifier (AUX) 620, Apparatus 200, and Display 250, of FIG. 2 configured to control RFT System 600 and perform acts associated with any of the steps shown in FIG. 7. In some exemplary embodiments, Tx-Ant 630 and Rx-Ant 640 may be horn antennas, such as Rupar antennas or any similar, commercially available antennas. In some exemplary embodiments, RFT System 600 may utilize AUX 620 for amplifying RF signals generated by Apparatus 200, of FIG. 2, up to tens of KW at frequencies ranging from 2 GHz to 12 GHz. It should be noted that the power setting may be proportional to a required survey penetration depth. For example, a few KW for a depth of 20 meters and a few tens of KW for a depth of up to 80 meters at frequencies ranging from 2 GHz to 12 GHz. In some exemplary embodiments, RFT System 600 is adapted to receive waves reflected from the Media 60 with Rx-Ants 640.

In some exemplary embodiments, RFT Systems 600, as well as Tx-Ant 630 and Rx-Ant 640, are permanently affixed to Vehicle 66 and move together along a trajectory above Media 60. In some exemplary embodiments, Apparatus 200 may comprise a positioning system (not shown), such as GPS, Real-Time Locating System (RTLS), and the like, or any combination thereof. In such embodiment, coordinates of each incremental-sampling (to be described in detail further below) of Tx-Ant 630 and Rx-Ant 640 relative to Media 60 may be provided by a positioning system (not shown).

In some exemplary embodiments, RFT System 600 may provide information comprising subsurface layers restoration (slices), detection and mapping of heterogencities in the subsurface layers, and determining location, shape, and size, in addition to digitally reconstructing and displaying 3D images of embedded objects' morphologies within a few seconds.

Referring now to FIG. 7 showing a flowchart diagram of a method, in accordance with some exemplary embodiments of the disclosed subject matter.

In Step 701, RF-transmission-signals may be transmitted. In some exemplary embodiments of the disclosed subject matter, RF-transmission-signals may be determined by Processor 210 (of FIG. 2) and transmitted by RF-Tx 221 using Tx-Ant 110 of Antenna 100 (of FIG. 2). In some exemplary embodiments, RF-Tx 221 may be configured as a multiport RF transmitter that generates UWB signals having sequential frequency hopping. It should be noted that parameters of the UWB signals, such as frequency range, frequency-discrete steps, and power magnitude for each signal are determined by Processor 210 and retained in Memory Unit 240, of Apparatus 200 (FIG. 2).

In some exemplary embodiments, RF-Tx 221 may be configured as a chirp signal generator representing a linear-frequency modulated signal with a fixed initial and final frequency.

In some exemplary embodiments, RF-Tx 221 may be configured as a UWB pulse generator that produces UWB signals in the time domain having a form of short amplitude bursts. The UWB pulse generator can be an oscillator circuit of RF-Tx 221 that generates a bipolar pulse having a predetermined shape and duration. Additionally, or alternatively, other signal processing devices may be used for signal tuning by frequency.

In some exemplary embodiments, RF-Tx 221 produces a multi-frequency, discrete or continuous frequency RF-transmission-signals having a determined frequency, amplitude and phase. It should be noted that the UWB pulse signal is limited in time with an equivalent frequency band, as is a multi-frequency signal.

In some exemplary embodiments, RF-transmission-signals are radiated on a surveyed media through a router (not shown) of RF-Tx 221, that routes the RF-transmission-signals to a plurality of transmitting antennas, i.e., Tx-Ants 110 of Antenna 100, according to a predetermined sequence and pattern controlled by Processor 210. Additionally, or alternatively, a synchronizing clock may be utilized to synchronize activities of RF-Tx 221 and RF-Rx 222 to minimize distortion of both the received and transmitted signals. In some exemplary embodiments, a broadband auxiliary RF amplifier, such as AUX 620 of FIG. 6, can be installed between RF-Tx 221 and a plurality of Tx-Ants 110 to increase the radiation power.

In Step 702, RF-signals may be received. In some exemplary embodiments of the disclosed subject matter, RF-signals may be received using at least one Rx-Ant 120 of Antenna 100 (of FIG. 1) amplified and processed by RF-Rx 222 (of FIG. 2).

In some exemplary embodiments, RF-Rx 222 may be configured to receive, by Antenna 100, RF-signals emitted from a radiated media, process them into raw data, and retain the raw data in Memory Unit 240, of FIG. 2. In some exemplary embodiments, the processing includes determining and retaining the amplitude, phase, and temporal shape of each received RF-signal.

In some exemplary embodiments, RF-signals may be simultaneously amplified and preprocessed by an RF-Rx 222 that comprises a multichannel receiver according to a predetermined sequence and pattern controlled by Processor 210. Thus, enabling simultaneous amplifying and preprocessing of a plurality of signals received by a plurality of antennas. Additionally, or alternatively, a sync clock may be utilized to synchronize activities of RF-Tx 221 and RF-Rx 222 to minimize distortion of both the received and transmitted signals.

In some exemplary embodiments, RF-Rx 222 may be configured to digitize RF-signals yielding digital values for each RF-signal that represent information comprising the frequency, the phase, and the amplitude of each acquired RF-signal. The information may be stored in an information-element in the raw data array of Memory Unit 240 (of FIG. 2) wherein each information-element is an independent component of the raw data array.

In some exemplary embodiments, RF-signals, such as UWB signals, chirp signals, and the like, or any combination thereof, may be received by RF-Rx 222. In addition, RF-Rx 222 may utilize an external wideband preamplifier to increase the gain of the received signals. The preamplifier may be connected between Antenna 100 and RF-Rx 222.

In Step 703, raw data from adjacent planes may be obtained. In some exemplary embodiments of the disclosed subject matter, raw data from adjacent planes can be obtained by incrementally moving (sliding) the aperture of both transmitting and receiving antennas along a trajectory that traverses the surveyed media and repeating Steps 701 and 702 for each adjacent plane. The process of executing Steps 701 and 702 for each incremental movement is referred to interchangeably herein as an “incremental-sampling”.

It will be appreciated that sliding the aperture of both (transmitting and receiving) antennas brings about projecting RF radiation, to impinge upon the media from different angles, and consequently, the received signals represent different angles, i.e., projections, and hence tomography. It will also be noted that smaller incremental movements translate to more adjacent planes, thus yielding a better spatial resolution, at the cost of a longer processing time.

In some exemplary embodiments, the incremental movement between adjacent plane should be equal or less than half the wavelength (2) corresponding to the maximum frequency in the spectrum of the received signal.

In some exemplary embodiments, the incremental movement (sliding) may be achieved by moving the media relative to the apertures, for example, RFT Systems 300 and 500 (of FIGS. 3 and 5 respectively) or moving the apertures relative to the media, for example, RFT Systems 400 and 600 (of FIGS. 4 and 6 respectively).

Additionally, or alternatively, utilizing an antenna array, such as Antenna 100 (of FIG. 1), enables sequential activation of the transmitting and the receiving antennas, such as Tx-Ants 110 and Rx-Ants 120 (of FIG. 1), which have different positions in Antenna 100. In some exemplary embodiments, a multichannel receiver, such as RF-Rx 222 (of FIG. 2), can speed up the amplifying and preprocessing step for each plane of the surveyed media. In some exemplary embodiments, a combination of physical movement and sequential activation of antennas of different positions in Antenna 100 may be utilized.

In some exemplary embodiments, the raw data may be comprised of a plurality of two-dimensional (2D) raw data arrays assembled by Processor 210 and retained in Memory Unit 240 (of FIG. 2). Each 2D raw data array may be comprised of a plurality of information-elements obtained from a different plane. Therefore, a combination of all 2D raw data arrays taken from all planes yields a three-dimensional raw data array (3D raw-data array) representing all information-elements taken from the surveyed media. 3D raw-data array is referred to interchangeably herein as a “spatial data grid”.

Furthermore, each element of each raw data array may incorporate, in addition to frequency phase and amplitude, coordinates of each incremental-sampling. i.e., coordinates of the antennas at each plane where Steps 701 and 702 were executed.

It should be noted that the spatial data grid should be filled with readings (no voids) to avoid image artifacts. It should also be noted that an area of a surveyed media, i.e., all planes, should be 2-3 times larger than the radiated object.

In Step 704, an RF-tomography technique may be invoked. In some exemplary embodiments of the disclosed subject matter, the RF-tomography technique of the present disclosure is designed to reconstruct a three-dimensional image from the 3D raw-data array, which describes the properties and morphologies of inhomogeneities inside the surveyed media.

In some exemplary embodiments, the RF-tomography technique may be configured for transmission applications, e.g., RFT Systems 300 of FIG. 3, or reflection applications, e.g., RFT Systems 400, 500, and 600 of FIGS. 4, 5, and 6 respectively, and a combination thereof. In some exemplary embodiments, a time domain, reflection-transform-algorithm (however, not limited to) may be used for reflection applications, and a frequency domain transmission-transform-algorithm (however, not limited to) may be used for transmission applications.

In some exemplary embodiments, the reflection-transform-algorithm may be manifested by the following mathematical expression #1:

$$E ( r , {r}_{0} ) = {k}^{2} {\int \int \int }_{{V}_{1}} Δε ( {r}_{1} ) {G}_{0} ( {r}_{1} - {r}_{0} ) {G}_{0} ( {r}_{1} - r ) {d}^{3} {r}_{1} .$$

Where G0 is a “Green's function” of the source relative to the distance between transmitter coordinates (r0) and coordinates of a receiver (r1) and (r) is a given point inside the object. In some exemplary embodiments, expression #1 can be resolved in the time domain using the following expression #2.

$$S ( r , {r}_{0} , t ) ≡ {k}_{0}^{2} \int \int {\int }_{{V}_{1}} Δε ( {r}_{1} ) \frac{{S}_{0} ( t - \frac{\vert {r}_{1} - {r}_{0} \vert + \vert {r}_{1} - r \vert}{c} )}{{( 4 π )}^{2} \vert {r}_{1} - {r}_{0} \vert \vert {r}_{1} - r \vert} {d}^{3} {r}_{1}$$

Where,

$${k}_{0} = \frac{2 π {f}_{0}}{c}$$

is a wave number corresponding to an average frequency of the transmitting signal spectrum. In the cases of a small inhomogeneity Δε(r1)=Δε₀δ(r₁-r₁₀).

In some exemplary embodiments, the reflection-transform-algorithm may include synthesized-focusing-techniques applied to received signals in order to obtain function Δε(r1) from expression #2. Synthesized-focusing techniques may be configured to collect the continuous sums of the received signals (stored in information-elements), which were reflected by points inside the object and their relative (propagation) time delays corresponding to transmission signals. The propagation time delay indicates a time difference between each RF-transmission-signal and each corresponding received RF-signal of each plane. In some exemplary embodiments, the corresponding time delay of each received RF-signal may be incorporated in each information-element of each plane of the 3D raw-data array.

In some exemplary embodiments, a synthesized-focusing-technique includes calculating an average time delay of all RF-signals, followed by summing together the measured values of all the RF-signals in the plane and normalizing the measured value of each RF-signal by the average time delay. This process may be repeated for all planes of the 3D raw-data array, which yields an outcome of a 3D raw-data array of focused signals.

In some exemplary embodiments, the synthesized focusing outcome executed by Apparatus 200 (of FIG. 2), applied on sufficient measured received signals, facilitates the definition of the distribution of dielectric field function Δε, thereby identifying object properties and morphologies.

It will be appreciated that synthesized-focusing-techniques may be comprised of inverse, single, two-step, group, and double focusing techniques and the like, or any combination thereof.

In some exemplary embodiments, the transmission-transform-algorithm is designed to determine morphologies and parameters of an object (Δε) subjected to radiation traversing through it, where the media, in which an object (Δε) is embedded, is situated between the receiving and transmitting antennas. Thus, determining the response of object (Δε), namely function Δε(r₁) of expression #1, in the frequency domain.

In some exemplary embodiments, the following mathematical expression #3 may be used to determine relation between distribution of the electric field in r-(space) domain and current (resulting from the radiating) in the wave number k-domain, i.e., or frequency domain.

$$E ( r ) = \frac{1}{{( 2 π )}^{2}} {\int }_{- ∞}^{∞} {\int }_{- ∞}^{∞} \frac{i}{2 {κ}_{z}} exp ( i κ r ) \hat{j} ( κ ) {d}^{2} {κ}_{⊥}$$

Where K=(Kₓ, K_{y}, K_{z}), K_{⊥}=(Kₓ, K_{y}), and K_{z}=\sqrt{k²−Kₓ²−K_{y}²}=\sqrt{k²−K_{⊥}²}

In some exemplary embodiments, the transmission-transform-algorithm may include a phase approximation where received RF-signals are recalculated using a mathematical approximation for turning 3D electrical field distribution into a 2D-dimensional distribution of the refractive index [n(x)] in the plane of focusing, i.e., frequency domain.

Implementation of the above-described reflection-transform-algorithm radiation shows radiation disturbances transmitted through an object are derived from phase differences in media. Thus, these differences can be described in the optical approximation so that the wave projection of the media inhomogeneities can be written in the following expression #4

$$E ( {r}_{2} , {r}_{1} ) = 2 {\int \int }_{{S}_{0}} {G}_{0} ( {r}_{s 0} - {r}_{1} ) \frac{{dG}_{0} ( {r}_{2} - {r}_{s 0} )}{dn} exp \{ ik \int Δ n ( {x}^{′} ) {dx}^{′} \} {dS}_{0}$$

In some exemplary embodiments, the transmission-transform-algorithm may include a synthesized-focusing-technique, such as the double focusing technique, that may be viewed as convolutions of focusing functions on two projections crossing each other. Such a double-focusing technique may be mathematically represented in the following expression #5

$${W}_{1} ( {r}_{F} , {r}_{1} ) = \frac{4}{i} \frac{{dG}_{*} ( {r}_{F} - {r}_{1} )}{dn} and {W}_{2} ( {r}_{F} , {r}_{s} ) = \frac{2}{i} {G}_{*} ( {r}_{F} - {r}_{2} ) .$$

Where, focusing point [r_{F}] lies in the plane [S₀], so that the focusing functions presented by expression #5 are focusing functions that allow using different synthesized-focusing-techniques, such as inverse, single, two-step, group, and double focusing techniques and any combination thereof. Thus, changing the impact in expression #4 and finally in tomography integration in the transverse directions for objects in surveyed media, which is manifested in expression #5 for both transverse directions.

$$\begin{matrix}U ( y , θ ) ≡ {\int \int }_{{S}_{1}} {\int \int }_{{S}_{2}} E ( {r}_{2} , {r}_{1} ) {W}_{1} ( {r}_{F} , {r}_{1} ) {W}_{2} ( {r}_{F} , {r}_{2} ) {dS}_{1} {dS}_{1} \approx \\ \approx exp \{ ik \int Δ n ( {x}^{′} ) {dx}^{′} \}\end{matrix} .$$

In Step 705, image data may be filtered. In some exemplary embodiments of the disclosed subject matter, the filtering is designed to eliminate artifacts and blurring from a reconstructed image, following an analysis of the image quality.

In some exemplary embodiments, the main causes of artifacts and blurred images are contributed by the permittivity of the surveyed media and the frequency range. In some exemplary embodiments, filtering comprises altering parameters associated with permittivity and frequency range and recalculating the synthesized-focusing functions followed by re-reconstructing the image. This procedure may be repeated until a sufficient image quality is obtained.

In some exemplary embodiments, image quality analysis includes measuring noise level, edge contrast, and the like. Additionally, or alternatively, neural network algorithms may be used to analyze image quality.

In Step 706, an image may be displayed. In some exemplary embodiments of the disclosed subject matter, the displayed image may depict a two or a three-dimensional view of the reconstructed image as well as various sections (planes) of the radio images.

It is to be understood that the disclosed subject matter is not limited in its application to the details of construction and the arrangement of the components set forth in the description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, some elements may have been omitted from some of the drawings.

The terms “comprises”, “comprising”, “includes”, “including”, and “having” together with their conjugates mean “including but not limited to”. The term “consisting of” has the same meaning as “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosed subject matter.

What is claimed is:

1. An electromagnetic aerial interface adapted to transmit and receive Radio Frequency (RF), the electromagnetic aerial interface comprising:
a plurality of conductors;
a dielectric base having a side that accommodates said plurality of conductors, wherein the side is configured to face a surveyed media, and said plurality of conductors transmit RF signals to the surveyed media and receive RF signals reflected by the surveyed media;
an adapter designed to control said plurality of conductors and conduct current to and from said plurality of conductors; and
wherein said adapter is utilized to assign conductors of said plurality of conductors to be used as a transmitter conductor or as a receiver conductor, and wherein conductors of said plurality of conductors are spaced apart from one another to avoid coupling between conductors assigned as transmitters and conductors assigned as receivers.

2. (canceled)

3. The electromagnetic aerial interface of claim 1, wherein each conductor of said plurality of conductors is designed to transmit and receive RF signals ranging from hundreds to thousands of Megahertz (MHz) at a variable power range and in different phases.

4. The electromagnetic aerial interface of claim 3, wherein said plurality of conductors are used for transmitting Extremely-Short-Pulses (ESP) and continuous RF signals in an Ultra-Wide-Band (UWB) frequency range.

5. The electromagnetic aerial interface of claim 1, wherein each conductor of said plurality of conductors is made of a conductive alloy and has a size that ranges from a few millimeters to 30 millimeters.

6. The electromagnetic aerial interface of claim 1, wherein conductors of said plurality of conductors are spaced apart from one another by a length smaller than 1.5 times an average wavelength of transmitting and receiving frequencies to ensure a radio tomography focusing.

7. The electromagnetic aerial interface of claim 1, wherein the side of said dielectric base has a geometric profile selected from the group including: flat, concave, convex, parabolic, and any combination thereof.

8. The electromagnetic aerial interface of claim 1, wherein said adapter switches said plurality of conductors from transmission to reception and vice versa.

9. The electromagnetic aerial interface of claim 1, wherein said adapter assigns a portion of conductors as transmitting conductors and another portion as receiving conductors, and wherein the transmitting conductors and the receiving conductors are enabled simultaneously or alternately.

10. The electromagnetic aerial interface of claim 1, wherein said adapter assigns a plurality of segments each comprising at least one conductor designated as a transmitting conductor and at least one conductor designated as a receiving conductor, wherein the segments are activated, by said adapter, in queues so that each segment project RF signals and receive reflected RF signals from a different angle.

11. A Radio-Frequency (RF) tomograph utilizing RF signals to determine objects present in and beyond a cluttered surveyed media, the RF tomograph comprising:
at least one electromagnetic aerial interface of claim 1;
an apparatus configured to produce RF-transmission-signals and process RF-signals and generate images depicting the objects;
a display configured to display the images and information associated with the images; and
wherein said apparatus uses said at least one electromagnetic aerial interface for transmitting RF-transmission-signals to the surveyed media and receiving RF-signals reflected from the surveyed media.

12. The RF tomograph of claim 11, wherein said apparatus is a computerized system comprising: a processor; an RF transmitter; an RF receiver; and a memory unit, wherein said RF transmitter is configured to shape RF-transmission-signals produced by said processor and transmit them by said at least one electromagnetic aerial interface and control said at least one electromagnetic aerial interface.

13. (canceled)

14. The RF tomograph of claim 12, wherein said RF receiver is configured to receive and preprocess RF-signals from said at least one electromagnetic aerial interface followed by converting them into digital raw data and storing the raw data in said memory unit.

15. The RF tomograph of claim 14, wherein said processor is also configured to reconstruct images from the raw data.

16. The RF tomograph of claim 14, wherein said apparatus further comprises an auxiliary input amplifier configured to assist said RF-receiver in amplifying RF-signals; and an auxiliary output amplifier configured to assist said RF transmitter in boosting up RF-transmission-signals.

17. (canceled)

18. The RF tomograph of claim 11, wherein said display is adapted to support graphic user interface functionalities to enable users of the RF tomograph to input information and instructions to said apparatus, and wherein said display is an integral part of said apparatus or connected to said apparatus as an external display selected from the group consisting of a touchscreen; a notepad; a laptop; a smartphone; a workstation; and any combination thereof.

19. The RF tomograph of claim 11 is an RF tomograph configured to operate in transmission applications, wherein said at least one electromagnetic aerial interface is comprised of one electromagnetic aerial interface configured as a receiving antenna and a second electromagnetic aerial interface configured as a transmitting antenna, wherein the transmitting antenna and the receiving antenna are facing opposite ends of the surveyed media, and wherein the RF tomograph moves the surveyed media between the transmitting antenna and the receiving antenna.

20. The RF tomograph of claim 11 is an RF tomograph configured to operate in reflection mode, wherein said at least one electromagnetic aerial interface is mounted on a movable device configured to move along the surveyed media while said at least one electromagnetic aerial interface transmit RF signals toward the surveyed media and receive reflected RF signals from the surveyed media, and wherein said apparatus synchronizes the signals with coordinates of the mobile device while moving along the surveyed media.

21. The RF tomograph of claim 11, wherein said at least one electromagnetic aerial interface is an antenna selected from the group including: a parabolic antenna, Rupor antenna, a Yagi antenna, an array antenna, and any combination thereof.

22. The RF tomograph of claim 21 is an RF tomograph configured to operate in reflection application that utilizes the antenna in stationary position, wherein the antenna is configured to transmit RF-transmission-signals adapted to penetrate a barrier and receive RF-signals reflected back, through the barrier from at least one entity moving behind the barrier, wherein said apparatus further comprises a camera configured to determine coordinates of at least one entity moving behind the barrier, and wherein said apparatus synchronizes the signals with coordinates of the at least one entity moving behind the barrier.

23. The RF tomograph of claim 21 is an RF tomograph configured to operate in reflection mode utilizing a receiving antenna and a transmitting antenna, wherein the receiving antenna and the transmitting antenna are mounted on a vehicle configured to move along the surveyed media while transmitting RF-transmission-signals toward the surveyed media and receiving reflected RF-signals from the surveyed media, and wherein said apparatus synchronizes the signals with coordinates of the vehicle while moving along the surveyed media.

24-39. (canceled)
